(19) United States
(12) Patent Application Publication
(10) Pub. No.: US 2007/0229058 A1
(43) Pub. Date: Oct. 4, 2007

(54) Displacement sensor

(76) Inventor: Ronald J. Wolf, Elkhart, IN (US)

Correspondence Address: Max W. Garwood, 450 N. Jefferson Street, P.O. Box 30, Huntington, IN, 46750, US

(21) Appl. No.: 11/394,395

(22) Filed: Mar. 31, 2006

(51) Int. Cl. G01B 7/14

(52) U.S. Cl. 324/207.24

(57) ABSTRACT

A linear displacement sensor including a hollow cylindrical flux concentrator, at least one magnetic flux sensor and a magnetic circuit. The hollow cylindrical flux concentrator has an inner opening and an outer surface. The at least one magnetic flux sensor is fixedly associated with the outer surface of the flux concentrator. The magnetic circuit is movable through the inner opening of the hollow cylindrical flux concentrator.

### BACKGROUND OF THE INVENTION

1. Field of the Invention

The present invention relates to a position sensor assembly, and, more particularly, to an electromagnetic position sensor.

2. Description of the Related Art

Electronic devices are an increasing part of everyday life and they are presently integrated in a large number of products, including products traditionally thought of as mechanical in nature, such as automobiles. To bridge the gap between mechanical movement and electronic control, it is necessary to successfully integrate electronic and mechanical components. This gap is normally bridged by using devices such as sensors and actuators.

Position sensors are used to electronically monitor the position or movement of a mechanical component. The position sensor produces data that may be expressed as an electrical signal that varies as the position or angular displacement of the mechanical component it is mounted to changes. Position sensors are an important part of innumerable products, providing the opportunity for intelligent control of mechanical devices.

Various contact-type sensors are known. For example, potentiometers are used to detect a change in electrical signal due to the physical change in position of a wiping contact on a resistive element. Rotational position and movement can be detected by coupling a shaft of a potentiometer to the shaft of a rotating mechanical component. Linear movement can be detected using either a linear potentiometer or a rotating potentiometer that is coupled to a linear-moving component using pulleys and a string or a belt to translate a linear motion to rotational motion. A problem with this type of sensor is the physical wearing of the rotating parts, the wiping contact, and the resistive element cause a drift in the electrical signal and lead to ultimate failure of the device.

Magnetic position sensors are generally a non-contact type of sensor and consist of a magnetic field sensing device, which is usually stationary, and a magnet is attached to a moving component. As the magnet approaches the sensing device, the magnetic field of the magnet is detected and the sensing device generates an electrical signal that is then used for counting, display purposes, recording and/or control purposes. A problem with such sensors is that they depend on a movement of the magnet, and they are not able to provide information as to the static position of a mechanical component.

Other magnetic position sensors provide an indication of the displacement of the mechanical component by using a magnetic field sensing device, which reports the intensity of a magnetic field from a magnet, which is positioned on a mechanical component. The magnet is positioned and the magnetic field sensing device is located relative to the magnet in such a fashion as to cause the magnetic field to vary in the magnetic field sensing device as the magnet moves. A magnetic field sensing device may detect a static magnetic field from a magnet and report the field strength as a representation of the position of the mechanical component.

A magnetic positional sensor developed by the inventor, patented as U.S. Pat. No. 5,818,223, entitled “Rotary Position Sensor with Circular Magnet,” discloses a Hall effect device disposed within a cylindrical-shaped magnet, the magnet having a magnetic field that varies from a north pole to a south pole as detected along a circular face of the magnet. The cylindrical magnet is mounted on a rotatable mechanical component and the Hall effect device is positioned inside the cylindrical magnet with an air gap therearound. The Hall effect device has flux concentrators mounted thereto. The magnetic field produced by the cylindrical magnet is detected by the Hall effect device, which in response thereto produces an electrical response representative of the magnet's position, and hence, the mechanical component's angular position.

Another invention of the applicant includes a dual-rail system with magnets located at each end, the rails providing a varying magnetic field therebetween from one end of the rails to the other based upon the magnets associated with each end of each rail.

What is needed in the art is a linear displacement sensor that is easily manufactured and is economical to produce.

### SUMMARY OF THE INVENTION

This invention relates to a linear displacement sensor, which provides a linear magnetic field as it moves through a flux concentrator.

The invention, in one embodiment, consists of a position sensing device including a magnetic flux sensing device, a flux concentrator and a magnetic circuit. The flux concentrator is in a fixed relationship to the magnetic flux sensing device and has a passageway therethrough. The magnetic circuit is movable through the passageway of the flux concentrator.

An advantage of the present invention is that the magnetic circuit is attachable to a first assembly and the flux sensing device, along with the flux concentrator, is mountable to another device with the magnetic circuit being insertable into the sensing device.

Another advantage of the present invention is that the magnetic circuit may travel beyond the useful sensing region and yet not be damaged by the physical movement as it is removed from the sensing unit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a linear displacement sensor of the present invention;

FIG. 2 is a schematicized cross-sectional view of the sensor of FIG. 1;

FIG. 3 is another schematicized cross-sectional view of the sensor of FIGS. 1 and 2;

FIG. 4 is a perspective view of another embodiment of a displacement sensor of the present invention;

FIG. 5 is a variation of the ring shown in FIG. 4;

FIG. 6 is a top view of the displacement sensor of FIG. 4; and

FIG. 7 is a partially sectioned view of the displacement sensor of FIGS. 4-6.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION OF THE PRESENT INVENTION

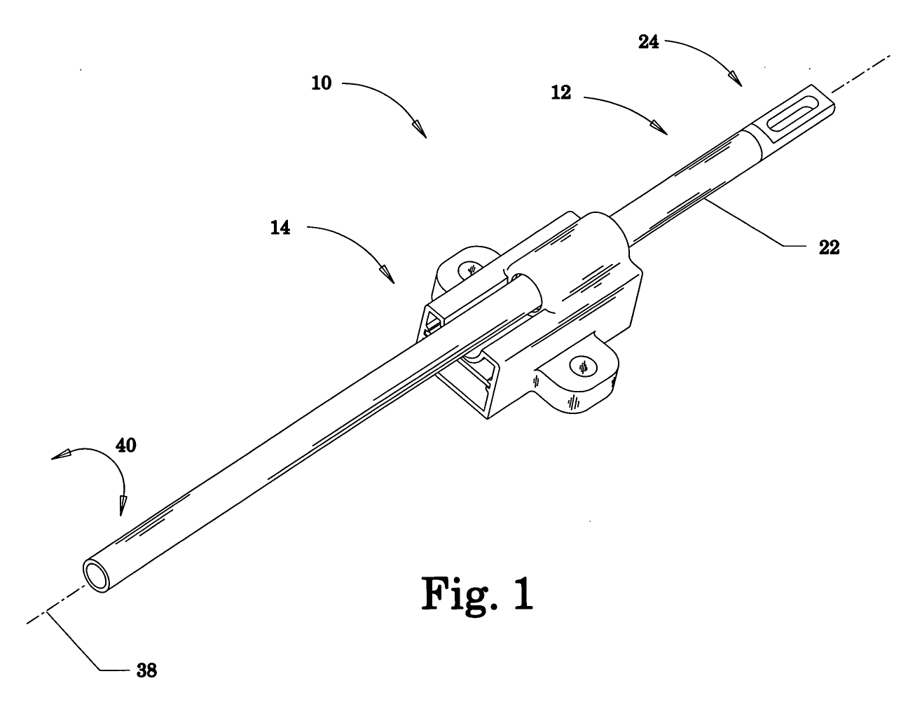

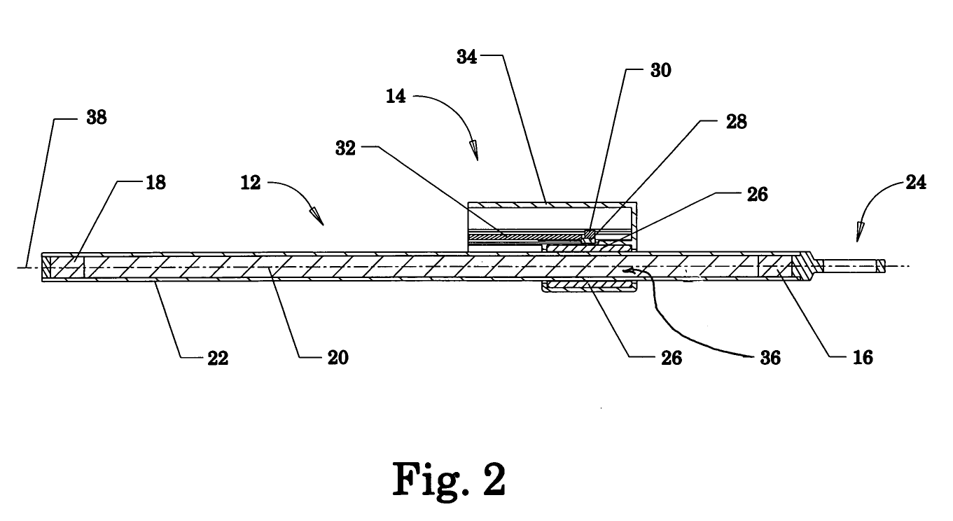

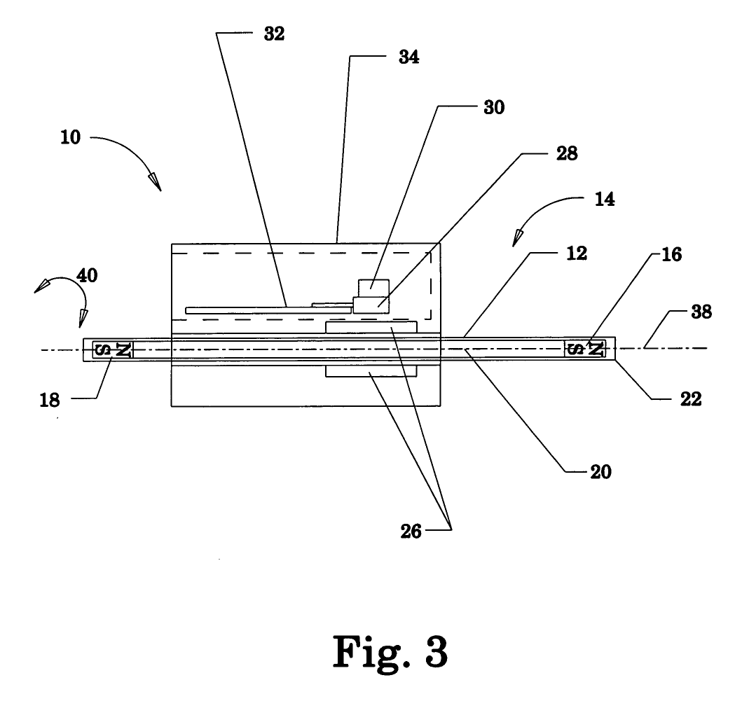

Referring now to the drawings, and more particularly to FIGS. 1-2, there is shown a sensor system 10 including a magnetic circuit 12 and a sensing assembly 14. Magnetic circuit 12 has a direction of travel that corresponds with longitudinal axis 38 and may be rotatable in rotational direction 40. Magnetic circuit 12 may be dynamically balanced to rotate about longitudinal axis 38 in rotational direction 40 and magnetic circuit 12 may be substantially cylindrical in nature.

Magnetic circuit 12 includes a magnet 16, a magnet 18, a ferrous rod 20, a nonmagnetic housing 22 and a mounting tab 24. Magnets 16 and 18 each have a north pole and a south pole with the south pole of magnet 16 coupled to one end of ferrous rod 20 and a north pole of magnet 18 being magnetically conductively connected to another end of ferrous rod 20. Nonmagnetic housing 22 surrounds magnets 16 and 18, and ferrous rod 20. Mounting tab 24 may be made of substantially the same material as nonmagnetic housing 22, and both may be of a plastic material. Although ferrous rod 20 is depicted as a substantially cylindrical rod, a non-cylindrical rod or one that varies in thickness may be included to alter the magnetic field along longitudinal axis 38. Although, additionally, one magnet may be used in magnetic circuit 12, two are used for illustration and is the preferred embodiment.

Sensing assembly 14 includes a flux concentrator 26, a magnetic flux sensing device 28, a flux concentrator 30, a printed circuit board 32 and a housing 34. Flux concentrator 26 may be a ferrous ring 26, having an opening or a passageway 36 therethrough. Although flux concentrator 26 is illustrated as a ring, flux concentrator 26 may have another shape, such as a U-shape, thereby allowing magnetic circuit 12 to be inserted into sensor assembly 14 perpendicular to axis 38. Magnetic circuit 12 is oriented and of an appropriate size and shape to pass through opening 36. Although a cylindrical magnetic circuit 12 is illustrated passing through a cylindrical opening 36, magnetic circuit 12 may take some other shape such as a ring shape with passageway 36 being curved to accommodate a ring-shaped magnetic circuit 12.

Magnetic flux sensing device 28 may be in the form of a Hall device 28 that is sensitive to the magnetic field changes that occur as magnetic circuit 12 is moved through passageway 36. Magnetic flux sensing device 28 is proximate to flux concentrator 26 and may be attached thereto. Hall device 28 may also have a flux concentrator 30 located on an opposite side of flux concentrator 26, relative to Hall device 28. Hall device 28 is electrically connected to printed circuit board 32 or to a wiring harness, not shown. Housing 34 is a nonmagnetic housing, such as a thermoplastic.

Sensing assembly 14 may be mounted to an apparatus that is movable relative to a related apparatus that is physically connected to magnetic circuit 12. As magnetic circuit 12 travels in either direction along longitudinal axis 38 through passageway 36, the magnetic field is concentrated by ferrous ring 26 and is detected by Hall device 28, thereby producing an electrical output from Hall 28 that corresponds in a linear fashion to the physical position of magnetic circuit 12. If magnetic circuit 12 rotates in rotational direction 40, this does not alter the magnetic field detected by Hall device 28, thereby allowing the apparatus, to which magnetic circuit 12 is attached, to rotate with only the movement along longitudinal axis 38 being detected. Although flux concentrator 26 is in the form of a ferrous ring, flux concentrator 30 may be more cubical in nature.

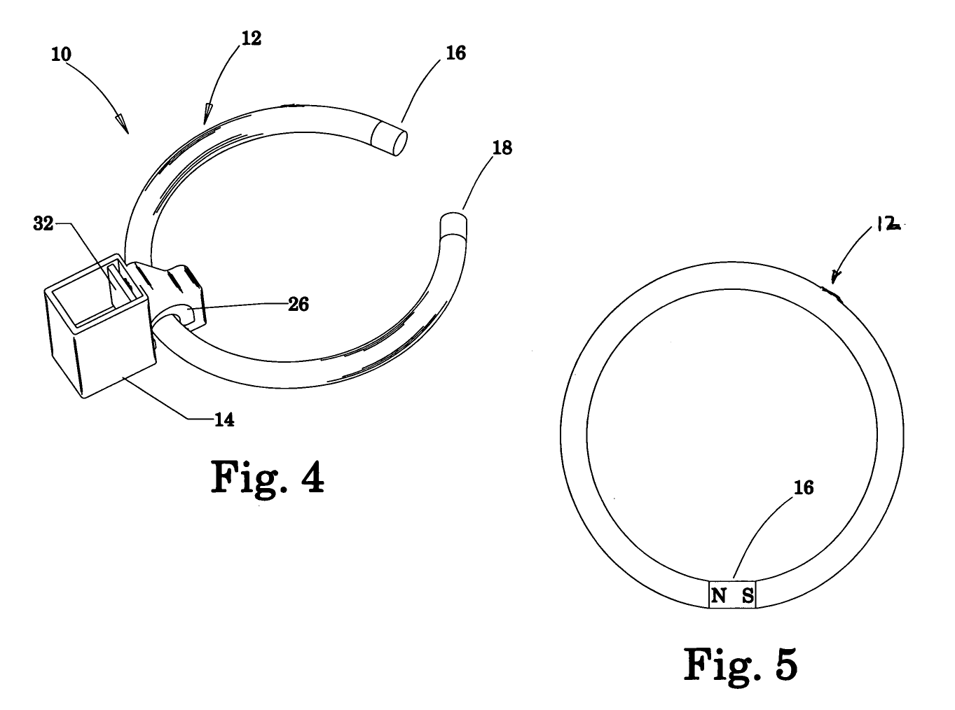

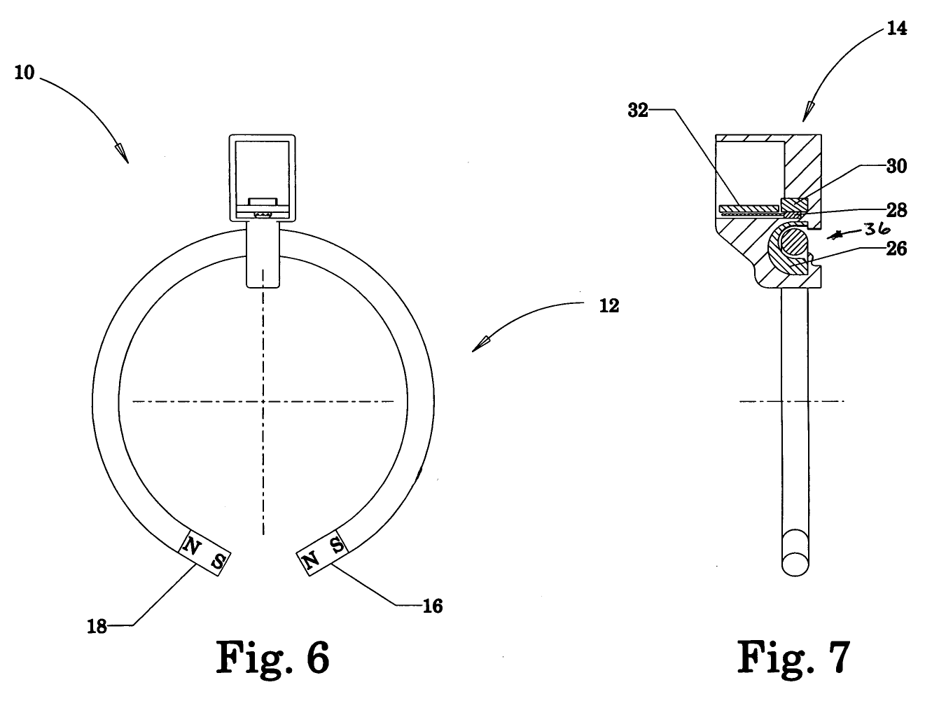

Now, additionally referring to FIGS. 4-7, there is shown another embodiment of a displacement sensor 10 where the magnetic circuit is curved, having either magnets 16 and 18 separated by an air gap, as illustrated in FIGS. 4 and 6, or as a unitary magnetic circuit as shown in FIG. 5. The embodiment of the present invention shown in FIG. 5 has only a single magnet 16 providing the magnetic field for magnetic circuit 12. Sensor assembly 14 includes a slot opening 36 through which magnetic circuit 12 rotatably passes. Other than magnetic circuit 12 moving in a rotatable direction, generally defined by the shape of magnetic circuit 12, the functioning of sensor system 10 is the same as that described for the previous embodiment. Magnetic circuit 12 may rotate relative to sensor assembly 14 in any manner as long as magnetic circuit 12 remains engaged within slot 36.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A position sensing device, comprising:
a magnetic flux sensing device;
a flux concentrator in a fixed relationship to said magnetic flux sensing device, said flux concentrator having a passageway;
a magnetic circuit movable through said passageway, said magnetic circuit includes a ferrous rod and at least two magnets including a first magnet and a second magnet, a north pole of said first magnet being magnetically coupled proximate to a first end of said ferrous rod, a south pole of said second magnet being magnetically coupled proximate to a second end of said ferrous rod; and
another flux concentrator, said flux concentrator on one side of said magnetic flux sensing device said another flux concentrator on an opposite side of said magnetic sensing device.

2. The position sensing device of claim 1, wherein said passageway connects two openings in said flux concentrator.

3. The position sensing device of claim 2, wherein said passageway is substantially cylindrical.

4. The position sensing device of claim 3, wherein said flux concentrator is substantially cylindrical.

5. The position sensing device of claim 1, wherein said magnet circuit has a longitudinal axis and is movable in a direction corresponding with said longitudinal axis.

6. (canceled)

7. The position sensing device of claim 1, wherein said first magnet, said second magnet and said ferrous rod are encapsulated in a non-magnetic housing.

8. The position sensing device of claim 5, wherein said magnetic circuit is rotatable in another direction about said longitudinal axis.

9. The position sensing device of claim 8, wherein said magnetic circuit is linear such that said magnetic flux sensing device does not detect rotational movement of said magnetic circuit in said other direction.

10. (canceled)

11. A displacement sensor, comprising:
a hollow, substantially cylindrical flux concentrator having an inner opening and an outer surface;
at least one magnetic flux sensor fixedly associated with said outer surface of said flux concentrator;
a magnetic circuit movable through said inner opening, said magnetic circuit including a ferrous rod and at least two magnets including a first magnet and a second magnet, a north pole of said first magnet being magnetically coupled with a first end of said ferrous rod, a south pole of said second magnet being magnetically coupled with a second end of said ferrous rod; and
another flux concentrator, said magnetic flux sensing device being sandwiched between said flux concentrator and said other flux concentrator.

12. The sensor of claim 11, wherein said magnetic circuit produces a substantially linear magnetic field from a position near one end of said magnetic circuit to a position near an opposite end of said magnetic circuit.

13. (canceled)

14. The sensor of claim 11, wherein said first magnet, said second magnet and said ferrous rod are enclosed in a non-magnetic housing.

15. The sensor of claim 11, wherein said magnetic circuit is rotatable in another direction about said longitudinal axis.

16. The sensor of claim 15, wherein said magnetic circuit is linear such that said magnetic flux sensing device does not detect rotational movement of said magnetic circuit in said other direction.

17. (canceled)

18. A displacement sensor, comprising:
a flux concentrator having an opening and an outer surface,
at least one magnetic flux sensor fixedly associated with said outer surface of said flux concentrator; and
a magnetic circuit movable through said opening, said magnetic circuit:
a longitudinally curved ferrous rod having a first end and a second end separated by a distance; and
a magnet having a first pole magnetically coupled with said first end of said curved ferrous rod and a second pole magnetically coupled with said second end of said curved ferrous rod.

19. The sensor of claim 18, wherein said flux concentrator has a cross-sectional U-shaped opening, said magnetic circuit movable within said U-shaped opening.

20. (canceled)
